(19) United States
(12) Patent Application Publication
(10) Pub. No.: US 2015/0338552 A1
(43) Pub. Date: Nov. 26, 2015

(54) OPTICAL COMPONENT

(71) Applicant: Asahi Glass Company, Limited, Tokyo (JP)

(72) Inventors: Kensuke Fujii, Tokyo (JP); Takaaki Murakami, Tokyo (JP); Akihiko Yoshihara, Tokyo (JP); Masao Miyamura, Tokyo (JP)

(73) Assignee: Asahi Glass Company, Limited, Tokyo (JP)

(21) Appl. No.: 14/816,176

(22) Filed: Aug. 3, 2015

Related U.S. Application Data
(63) Continuation of application No. PCT/JP2014/052969, filed on Feb. 7, 2014.

(30) Foreign Application Priority Data
Feb. 22, 2013 (JP) 2013-033388

(51) Int. Cl. G02B 1/115

(52) U.S. Cl. CPC G02B 1/115

(57) ABSTRACT

An optical component includes a transparent base body, an anti-reflection coating stacked on the transparent base body, and an anti-smudge coating stacked on the anti-reflection coating. The surface roughness Ra of the anti-smudge coating is 3 nm or less.

### CROSS-REFERENCE TO RELATED APPLICATIONS

The present application is a continuation application filed under 35 U.S.C. 111(a) claiming benefit under 35 U.S.C. 120 and 365(c) of PCT International Application No. PCT/JP2014/052969, filed on Feb. 7, 2014 and designating the U.S., which claims priority to Japanese Patent Application No. 2013-033388, filed on Feb. 22, 2013. The entire contents of the foregoing applications are incorporated herein by reference.

### TECHNICAL FIELD

The present invention relates to optical components.

### BACKGROUND ART

In various kinds of display apparatuses such as liquid crystal displays, imaging apparatuses such as cameras, and various kinds of optical apparatuses, a protection member for protecting a display member and an imaging device, an optical function member (hereinafter also referred to as “optical component”) such as a lens that is a component of the apparatuses, etc., are used.

According to such an optical component, a transparent base body is used in order to transmit light, and an anti-reflection coating is further provided on a surface of the transparent base body. This is for preventing lowering visibility by reflection light. Furthermore, an anti-smudge coating is further provided on the anti-reflection coating in order to make smudges less likely to adhere and more likely to be removed because adhesion of oil, sweat or a cosmetic material due to contact with a human finger or the like at the time of use affects visibility, etc.

There is a problem, however, in that when smudges adhere to the anti-smudge coating, wiping a surface of the anti-smudge coating with cloth or the like many times results in removal of part or sometimes the entirety of the anti-smudge coating, thus reducing resistance to contamination. Thus, study has been made of a method of increasing the durability of the anti-smudge coating.

For example, Japanese Laid-Open Patent Application No. 2001-281412 discloses an anti-reflection member in which an anti-smudge layer is formed that is made of a predetermined compound in order to increase the durability of the anti-smudge layer.

### SUMMARY OF THE INVENTION

According to an aspect of the present invention, an optical component includes a transparent base body, an anti-reflection coating stacked on the transparent base body, and an anti-smudge coating stacked on the anti-reflection coating. The surface roughness Ra of the anti-smudge coating is 3 nm or less.

### BRIEF DESCRIPTION OF THE DRAWINGS

FIG. 1 is a diagram illustrating a configuration of an optical component according to an embodiment of the present invention;

FIG. 2 is an SEM image of an optical component according to Experimental Example 1; and

FIG. 3 is an SEM image of an optical component according to Experimental Example 6.

### DETAILED DESCRIPTION OF THE PREFERRED EMBODIMENTS

According to the anti-reflection member of Japanese Laid-Open Patent Application No. 2001-281412, however, the durability of the anti-smudge layer is improved to a certain extent but is still short of being sufficient for practical use. Therefore, there has been a demand for a further increase in the durability of the anti-smudge layer.

According to an aspect of the present invention, it is possible to provide an optical component including an anti-reflection coating and an anti-smudge coating stacked on a transparent base body, where the durability of the anti-smudge coating is increased.

A description is given below, with reference to the drawings, of an embodiment of the present invention. The present invention is not limited to the below-described embodiment, and variations and replacements may be made to the below-described embodiment without departing from the scope of the present invention.

In this embodiment, a description is given of an optical component of the present invention.

An optical component of this embodiment includes a transparent base body, an anti-reflection coating stacked on the transparent base body, and an anti-smudge coating stacked on the anti-reflection coating, and has a feature that a surface roughness Ra of the anti-smudge coating is 3 nm or less.

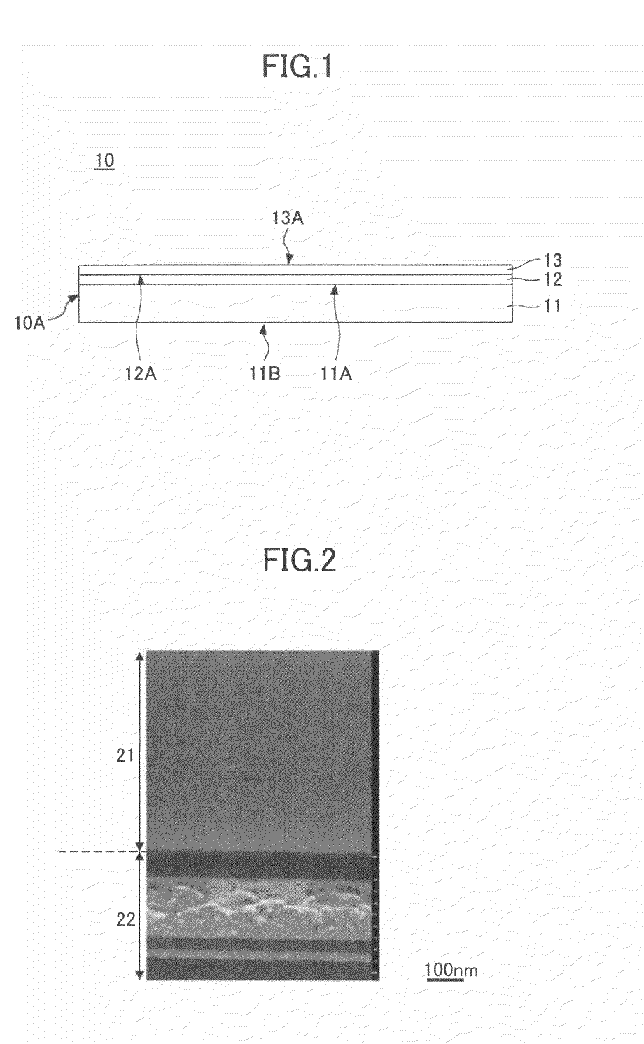

A description is given, using FIG. 1, of the optical component of this embodiment. FIG. 1 schematically illustrates a cross-sectional view of an optical component 10 according to this embodiment, where an anti-reflection coating 12 is stacked on a transparent base body 11, and an anti-smudge coating 13 is stacked on the anti-reflection coating 12. A description is given below of each member of the optical component 10.

The material of the transparent base body 11 is not limited in particular, and various kinds of transparent base bodies may be used as long as they transmit at least visible light. Examples of transparent base bodies include a plastic substrate, a sapphire substrate, and a glass substrate. Among them, the glass substrate is preferable as a transparent base body in light of transparency, strength, etc. Furthermore, it is preferable to use a sapphire substrate as a transparent base body particularly for use where strength is required.

In the case of using a glass substrate as a transparent base body, glass is not limited to a particular kind, and various kinds of glass such as alkali-free glass, soda-lime glass, and aluminosilicate glass may be used. Among them, the soda-lime glass is preferably used in light of adhesion to a layer provided on its upper surface.

When the transparent base body 11 is a glass substrate, it is preferable to use a strengthened glass substrate of chemically strengthened aluminosilicate glass (such as “Dragontrail (registered trademark)”) in light of the strength of the transparent base body itself.

Chemical strengthening refers to a process to replace alkali ions of a smaller ion radius (such as sodium ions) on a glass surface with alkali ions of a larger ion radius (such as potassium ions). For example, glass containing sodium ions may be treated with a molten salt containing potassium ions to be chemically strengthened. The composition of a compressive stress layer at a surface of such a chemically strengthened glass substrate is slightly different from the composition before ion exchange, but the composition of a deep layer part of the substrate is substantially the same as the composition before chemical strengthening.

Conditions for chemical strengthening are not limited in particular, and may be suitably selected in accordance with the kind of glass to be subjected to chemical strengthening, a required degree of chemical strengthening, etc.

A molten salt for performing chemical strengthening may be selected in accordance with a glass base material to be subjected to chemical strengthening. Examples of molten salts for performing chemical strengthening include potassium nitrate, and alkali sulfates and alkali chlorides such as sodium sulfate, potassium sulfate, sodium chloride, and potassium chloride. These molten salts may be used alone or in combination of multiple kinds.

Heating temperature for the molten salt is preferably 350° C. or higher, and more preferably, 380° C. or higher, and is preferably 500° C. or lower, and more preferably, 480° C. or lower.

By setting heating temperature for the molten salt at 350° C. or higher, it is possible to prevent the rate of ion exchange from becoming excessively low to make chemical strengthening less likely to occur. Furthermore, by setting heating temperature for the molten salt at 500° C. or lower, it is possible to prevent decomposition and degradation of the molten salt.

Furthermore, the time for which glass is brought in contact with the molten salt is preferably 1 hour or more, and more preferably, two hours or more, in order to provide the glass with a sufficient compressive stress. Furthermore, ion exchange, which lowers productivity and decreases a compressive stress value because of relaxation when performed for a long time, is preferably 24 hours or less, and more preferably, 20 hours or less.

The shape of the transparent base body 11 also is not limited in particular, and the shape may be selected in accordance with various uses of the optical component. For example, the shape may be a plate shape illustrated in FIG. 1 or a shape that includes a curved surface or a spherical surface in its surface.

The surface roughness Ra of the transparent base body 11 is not limited in particular, but as described above, according to the optical component of this embodiment, the surface roughness Ra of the anti-smudge coating 13 is 3 nm or less. Furthermore, the anti-smudge coating 13 is stacked on the anti-reflection coating 12, and the anti-reflection coating 12 is stacked on the transparent base body 11. Therefore, in order for the anti-smudge coating 13 to more easily have the surface roughness Ra in the above-described range, a surface 11A of the transparent base body 11 on which the anti-reflection coating 12 is stacked and a surface 12A of the anti-reflection coating 12 on which the anti-smudge coating 13 is stacked preferably have the same surface roughness Ra. That is, the surface roughness Ra is preferably 3 nm or less with respect to the surface 11A of the transparent base body 11 on which the anti-reflection coating 12 and the anti-smudge coating 13 are stacked in order. Furthermore, as described below, the surface roughness Ra of the anti-smudge coating 13 is more preferably 2 nm or less, and still more preferably, 1.5 nm or less. Accordingly, the surface roughness Ra of the surface 11A of the transparent base body 11 on which the anti-reflection coating 12 and the anti-smudge coating 13 are stacked in order is more preferably 2 nm or less, and still more preferably, 1.5 nm or less.

The lower limit value of the surface roughness Ra of the surface 11A of the transparent base body 11 on which the anti-reflection coating 12 and the anti-smudge coating 13 are stacked in order is not limited in particular, but is preferably 0.1 nm or more, and more preferably 0.5 nm or more the same as in the case of the below-described surface of the anti-smudge coating 13.

The surface roughness Ra of a surface of the transparent base body 11 on which neither the anti-reflection coating 12 nor the anti-smudge coating 13 is stacked or the anti-reflection coating 12 alone is stacked may be arbitrarily selected in accordance with the use or the like of the optical component.

Here, the surface roughness Ra is the average value of absolute value deviations from a reference plane in a roughness curve included in a reference length on the reference plane, and indicates more proximity to a complete smooth surface as the value becomes closer to zero.

Furthermore, the anti-reflection coating 12 is stacked on at least one of the surfaces of the transparent base body 11 as illustrated in FIG. 1.

The anti-reflection coating 12 is capable of preventing reflection of light at a surface of the optical component 10. Therefore, when an optical component with an anti-reflection coating is used as a cover member for a display apparatus, it is possible to prevent reflection of ambient light and to improve the display visibility of the display apparatus. Furthermore, when such an optical component is used as a lens of a camera, it is possible to prevent reflection of light and to capture a clear image.

The material of the anti-reflection coating is not limited in particular, and various kinds of materials may be used as long as they are capable of preventing reflection of light. For example, the anti-reflection coating may be a stack of a high refractive index layer and a low refractive index layer. Here, the high refractive index layer is a layer whose refractive index at a wavelength of 550 nm is 1.9 or more, and the low refractive index layer is a layer whose refractive index at a wavelength of 550 nm is 1.6 or less.

One high refractive index layer and one low refractive index layer may be included or two or more high refractive index layers and two or more low refractive index layers may be included. In the case where two or more high refractive index layers and two or more low refractive index layers are included, it is preferable that the high refractive index layers and the low refractive index layers be alternately stacked.

In particular, in order to improve the reflection prevention performance, the anti-reflection coating is preferably a stack of multiple stacked layers, and for example, the stack is preferably a stack of two to six layers, and more preferably, a stack of two to four layers in total. Here, the stack is preferably a stack of stacked high and low refractive index layers as described above, and the total of the number of high refractive index layers and the number of low refractive index layers preferably falls within the above-described range.

The materials of the high and low refractive index layers are not limited in particular, and may be selected in view of a required degree of reflection prevention, productivity, etc. As a material forming the high refractive index layer, one or more selected from, for example, niobium oxide (Nb₂O₅), titanium oxide (TiO₂), zirconium oxide (ZrO₂), silicon nitride (SiN), and tantalum oxide (Ta₂O₅) may be preferably used. As a material forming the low refractive index layer, one or more selected from silicon oxide (SiO₂), a material containing a mixed oxide of Si and Sn, a material containing a mixed oxide of Si and Zr, and a material containing a mixed oxide of Si and Al may be preferably used.

More preferably, in terms of productivity and a degree of refractive index, the high refractive index layer is formed of one selected from a niobium oxide layer and a tantalum oxide layer and the low refractive index layer is a silicon oxide layer.

Furthermore, in light of the hardness of a coating material and surface roughness, it is more preferable that the high refractive index layer is a silicon nitride layer and the low refractive index layer is one of a material containing a mixed oxide of Si and Sn, a material containing a mixed oxide of Si and Zr, and a material containing a mixed oxide of Si and Al

According to the optical component of this embodiment, the anti-reflection coating 12 is provided on at least one side of the transparent base body 11. Alternatively, the anti-reflection coating 12 may be provided on both surfaces of the transparent base body 11, that is, provided on each of the surface 11A and a surface 11B of FIG. 1.

As described above, according to the optical component of this embodiment, the surface roughness Ra of the anti-smudge coating 13 formed on the anti-reflection coating 12 is 3 nm or less. If the surface roughness Ra of the anti-smudge film is more than 3 nm, applied pressure concentrates on convex parts of the anti-smudge coating when the anti-smudge coating is rubbed with cloth or the like. As a result, it is believed that a shear stress on the surface of the anti-smudge coating in the parts increases so as to make the anti-smudge coating more likely to be removed. On the other hand, if the surface roughness Ra of the anti-smudge film is 3 nm or less, cloth or the like is allowed to deform along the uneven shape of the surface so as to apply a load evenly on the entire surface of the anti-smudge coating. Accordingly, it is believed that a shear stress on the surface of the anti-smudge coating is reduced so as to prevent removal of the anti-smudge coating.

In order to make it easier for the surface roughness Ra of the anti-smudge coating 13 to fall within the above-described range, it is preferable that the surface roughness Ra be 3 nm or less with respect to a surface of the anti-reflection coating 12 that faces the anti-smudge coating 13 (for example, the surface 12A in the case of FIG. 1) as well.

Furthermore, in light of further reducing a shear stress on the surface of the anti-smudge coating, the surface roughness Ra of the anti-smudge coating 13 is more preferably 2 nm or less, and still more preferably, 1.5 nm or less. Accordingly, the surface roughness Ra of the surface 12A of the anti-reflection coating 12 that faces the anti-smudge coating 13 is more preferably 2 nm or less, and still more preferably, 1.5 nm or less.

The lower limit value of the surface roughness Ra of the surface 12A of the anti-reflection coating 12 that faces the anti-smudge coating 13 is not limited in particular, but is preferably 0.1 nm or more, and more preferably 0.5 nm or more the same as in the case of the below-described surface of the anti-smudge coating 13.

The anti-smudge coating 13 is formed on a surface that may be touched by a human hand as described below. Therefore, even when the anti-reflection coating 12 is provided on each side of a transparent base material, the anti-smudge coating 13 may be provided on only one of the anti-reflection coatings. In this case, the surface roughness of the anti-reflection coating on which the anti-smudge coating is not provided may be arbitrarily selected in accordance with the use of the optical component.

The method of depositing the anti-reflection coating 12 is not limited in particular, and various kinds of deposition methods may be used. In particular, in order for the value of the surface roughness Ra of its surface to fall within the above-described preferred range, it is preferable to perform deposition by methods such as pulsed sputtering, AC sputtering, and digital sputtering. In pulsed sputtering and AC sputtering, more plasma energy reaches a substrate or molecules for deposition reaches a substrate with more energy than in normal magnetron sputtering. Therefore, it is believed that rearrangement of deposited molecules is promoted, so that a dense, smooth film is formed.

For example, when deposition is performed by pulsed sputtering, deposition can be performed by placing the transparent base body 11 in a chamber of a mixed gas atmosphere of an inert gas and oxygen gas and selecting, with respect to this, a target so that a desired composition is obtained.

At this point, the inert gas in the chamber is not limited to a particular gaseous species, and various kinds of inert gases such as argon and helium may be used.

The pressure inside the chamber due to a gas mixture of the inert gas and oxygen gas is not limited in particular, and is preferably 0.5 Pa or less because this makes it possible for the surface roughness of the surface of the anti-reflection coating to easily fall within the above-described preferred range. It is believed that this is because when the pressure inside the chamber due to a gas mixture of an inert gas and oxygen gas is 0.5 Pa or less, the mean free path of molecules for deposition is ensured and the molecules for deposition reaches a substrate with more energy, so that rearrangement of deposited molecules is promoted to form a film having a relatively dense, smooth surface. The lower limit value of the pressure inside the chamber due to a gas mixture of an inert gas and oxygen gas is not limited in particular, and is preferably, for example, 0.1 Pa or more.

Furthermore, unlike normal magnetron sputtering, digital sputtering is a method of depositing a metal oxide thin film that repeats, in the same chamber, the process of first depositing an extremely thin metal film by sputtering and then oxidizing it by exposing it to an oxygen plasma, oxygen ions, or oxygen radicals. In this case, when deposited on a substrate, molecules for deposition are metal. Therefore, compared with the case of depositing as a metal oxide, it is inferred that molecules for deposition are ductile. Accordingly, it is believed that rearrangement of deposited molecules is more likely to occur even with the same energy, so that a dense, smooth film is formed.

Next, a description is given of the anti-smudge coating 13. The anti-smudge coating 13 may be formed of a fluorinated organosilicon compound.

Here, a description is given of fluorinated organosilicon compounds. Fluorinated organosilicon compounds that may be used according to this embodiment are not limited in particular as long as they provide an anti-smudge characteristic, water repellency, and oil repellency.

As such fluorinated organosilicon compounds, for example, fluorinated organosilicon compounds that include one or more groups selected from the group consisting of a polyfluoropolyether group, a polyfluoroalkylene group, and a polyfluoroalkyl group may be preferably used. The polyfluoropolyether group refers to a bivalent group having a structure where polyfluoroalkylene groups and etheric oxygen atoms are alternately bonded.

Specific examples of the fluorinated organosilicon compounds that include one or more groups selected from the group consisting of a polyfluoropolyether group, a polyfluoroalkylene group, and a polyfluoroalkyl group include compounds and the like represented by the following general formulae (I) to (V).

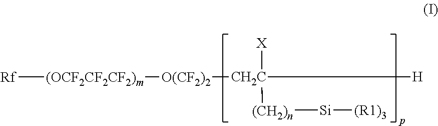

In the formula, Rf is a C₁₋₁₆ straight chain polyfluoroalkyl group (where the alkyl group is, for example, a methyl group, an ethyl group, an n-propyl group, an isopropyl group, an n-butyl group or the like), X is a hydrogen atom or a C₁₋₅ lower alkyl group (such as a methyl group, an ethyl group, an n-propyl group, an isopropyl group, or an n-butyl group), R1 is a hydrolyzable group (such as an amino group or an alkoxy group) or a halogen atom (such as fluorine, chlorine, bromine, or iodine), m is an integer of 1 to 50, preferably 1 to 30, n is an integer of 0 to 2, preferably 1 to 2, and p is an integer of 1 to 10, preferably 1 to 8.

C_{q}F_{2q+1}CH₂CH₂Si(NH₂)₃ (II)

Here, q is an integer greater than or equal to 1, preferably an integer of 2 to 20.

Examples of compounds represented by the general formula (II) include n-trifluoro(1,1,2,2-tetrahydro)propyl silazane (n-CF₃CH₂CH₂Si(NH₂)₃) and n-heptafluoro(1,1,2,2-tetrahydro)pentyl silazane (n-C₃F₇CH₂CH₂Si(NH₂)₃).

C_{q′}F_{2q′+1}CH₂CH₂Si(OCH₃)₃ (III)

Here, q′ is an integer greater than or equal to 1, preferably an integer of 1 to 20.

Examples of compounds represented by the general formula (III) include 2-(perfluorooctyl)ethyltrimethoxysilane (n-C₈F₁₇CH₂CH₂Si(OCH₃)₃.

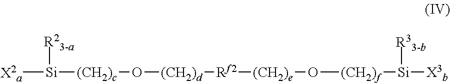

In the formula (IV), Rf² is a bivalent straight chain polyfluoropolyether group represented by —(OC₃F₆)ₛ—(OC₂F₄)ₜ—(OCF₂)ᵤ— (where each of s, t, and u is independently an integer of 0 to 200), and R² and R³ are each independently a C₁₋₈ monovalent hydrocarbon group (such as a methyl group, an ethyl group, an n-propyl group, an isopropyl group or an n-butyl group), X² and X³ are independently a hydrolyzable group (such as an amino group, an alkoxy group, an acyloxy group, an alkenyloxy group or an isocyanate group) or a halogen atom (such as a fluorine atom, a chlorine atom, a bromine atom or an iodine atom), d and e are independently an integer of 1 to 2, c and f are independently an integer of 1 to 5 (preferably 1 to 2), and a and b are independently 2 or 3.

In R^{f2} of the compound (IV), s+t+u is preferably 20 to 300, and more preferably, 25 to 100. Furthermore, R² and R³ are more preferably a methyl group, an ethyl group or a butyl group. The hydrolyzable group represented by X² or X³ is more preferably a C₁₋₆alkoxy group, and particularly preferably a methoxy group or an ethoxy group. Furthermore, each of a and b is preferably 3.

F—(CF₂)ᵥ—(OC₃F₆)_{w}—(OC₂F₄)^{y}—(OCF₂)_{z}(CH₂)ₕO(CH₂)ᵢ—Si(X⁴)₃₋ₖ(R⁴)ₖ (V)

In the formula (V), v is an integer of 1 to 3, w, y and z are each independently an integer of 0 to 200, h is 1 or 2, i is an integer of 2 to 20, X⁴ is a hydrolyzable group, R⁴ is a C₁₋₂₂ linear or branched hydrocarbon group, and k is an integer of 0 to 2, where w+y+z is preferably 20 to 300, and more preferably, 25 to 100 . Furthermore, i is more preferably 2 to 10. X⁴ is preferably a C₁₋₆ alkoxy group, and more preferably, a methoxy group or an ethoxy group. R⁴ is more preferably a C₁₋₁₀ alkyl group.

Furthermore, as commercially available fluorinated organosilicon compounds that include one or more groups selected from the group consisting of a polyfluoropolyether group, a polyfluoroalkylene group, and a polyfluoroalkyl group, KP-801 (product name, manufactured by Shin-Etsu Chemical Co., Ltd.), KY-178 (product name, manufactured by Shin-Etsu Chemical Co., Ltd.), KY-130 (product name, manufactured by Shin-Etsu Chemical Co., Ltd.), KY-185 (product name, manufactured by Shin-Etsu Chemical Co., Ltd.), and Optool (registered trademark) DSX and Optool (registered trademark) AES (both product names, manufactured by Daikin Industries, Ltd.) may be preferably used.

Fluorinated organosilicon compounds are generally stored in a mixture with a solvent such as a fluorinated solvent in order to prevent degradation due to reaction with moisture in the air, and may have adverse effect on the durability of an obtained thin film if used in a deposition process while containing such a solvent.

Therefore, according to this embodiment, it is preferable to use fluorinated organosilicon compounds subjected in advance to a solvent removal process before being heated in a heating container or fluorinated organosilicon compounds that are not diluted with a solvent (to which no solvent is added). For example, the concentration of a solvent contained in a fluorinated organosilicon compound solution is preferably 1 mol % or less, and more preferably, 0.2 mol % or less. It is particularly preferable to use fluorinated organosilicon compounds that contain no solvent.

Examples of solvents that are used in storing the above-described fluorinated organosilicon compounds include perfluorohexane, m-xylene hexafluoride (C₆H₄(CF₃)₂), hydrofluoropolyether, and HFE7200/7100 (product name, manufactured by Sumitomo 3M Ltd., where HFE7200 is represented by C₄F₉C₂H₅ and HFE7100 is represented by C₄F₉OCH₃).

From a fluorinated organosilicon compound solution that contains a fluorinated solvent, the solvent (solvent medium) may be removed by, for example, evacuating a container that contains the fluorinated organosilicon compound solution.

The time for evacuation, which varies depending on the evacuation capabilities of an evacuation line, a vacuum pump, etc., and the amount of the solution, is not limited, and the evacuation may be performed for, for example, approximately 10 hours or more.

The method of depositing an anti-smudge coating according to the present invention is not limited in particular, and it is preferable to deposit an anti-smudge coating by vacuum deposition using materials as described above.

In this case, the above-described solvent removal process may be performed, after introduction of a fluorinated organosilicon compound solution into the heating container of a deposition apparatus for depositing an anti-smudge coating, by evacuating the heating container at room temperature before temperature rises. Furthermore, the solvent may alternatively be removed in advance with an evaporator or the like before introduction of the solution into the heating container.

As described above, however, fluorinated organosilicon compounds of a low or no solvent content are more likely to degrade through contact with the air than those containing a solvent.

Therefore, it is preferable to use an airtight container whose inside is replaced with an inert gas such as nitrogen to store fluorinated organosilicon compounds of a low (or no) solvent content, and to try to reduce the time of exposure to and contact with the air as much as possible at the time of their handling.

Specifically, it is preferable to introduce a fluorinated organosilicon compound into the heating container of the deposition apparatus for depositing an anti-smudge coating immediately after opening the storage container. Furthermore, after the introduction, it is preferable to remove the air contained in the heating container by evacuating the heating container or replacing the inside of the heating container with an inert gas such as nitrogen or a noble gas. In order to allow introduction from the storage container into the heating container of this deposition apparatus without contact with the air, for example, the storage container and the heating container are more preferably connected by a pipe with a valve.

Furthermore, it is preferable to start heating for deposition immediately after evacuation of the heating container or replacement of its inside with an inert gas after introduction of a fluorinated organosilicon compound into the container.

The method of depositing an anti-smudge coating is not limited to the example illustrated in the description of this embodiment, which uses a solution or undiluted solution of a fluorinated organosilicon compound. Examples of other methods include a method that uses commercially available so-called deposition pellets (for example, SURFCLEAR manufactured by Canon Optron Inc.), which are porous metal (such as tin or copper) or fibriform metal (such as stainless steel) impregnated in advance with a certain amount of a fluorinated organosilicon compound. In this case, it is possible to simply deposit an anti-smudge coating using, as a deposition source, pellets of an amount commensurate with the capacity of a deposition apparatus and a required film thickness.

As described above, the anti-smudge coating 13 is stacked on the anti-reflection coating 12. For example, in the case where the anti-reflection coating 12 is deposited on each of the surfaces (11A and 11B) of the transparent base body 11 as described above, an anti-smudge coating may be deposited on each anti-reflection coating 12, while the anti-smudge coating 13 may alternatively be stacked on only one of the surfaces. This is because it is sufficient that the anti-smudge coating 13 is provided at a location that may be touched by a human hand or the like, and selection may be made according to its purpose or the like.

With respect to the anti-smudge coating of this embodiment, the surface roughness Ra is 3 nm or less, more preferably, 2 nm or less, and still more preferably, 1.5 nm or less. Such a range of the surface roughness of the surface of the anti-smudge coating 13 makes it possible to improve the durability of the anti-smudge coating 13.

The lower limit value of the surface roughness Ra of the anti-smudge coating 13 is not limited in particular, and is preferably 0.1 nm or more, and more preferably, 0.5 nm or more.

The optical component of this embodiment has been described above. The haze of the optical component of this embodiment is preferably 1% or less, and more preferably, 0.5% or less. By setting the haze to this value, it is possible, as an imaging device protection member, to capture a clearer image by suppressing diffusion of entering light. Furthermore, as a display apparatus protection member, it is possible to display a clearer image.

Accordingly, in various kinds of display apparatuses such as liquid crystal displays, imaging apparatuses such as cameras, and various kinds of optical apparatuses, it may be more preferably used as a protection member (cover member) for protecting a display member or an imaging device, an optical function member such as a lens that is a component of the above-described apparatuses, and the like.

### EXAMPLES

A description is given below of specific examples, but the present invention is not limited to these examples.

### (1) Evaluation Method

A description is given below of a method of evaluating properties of optical components obtained in the following experimental examples.

### [Measurement of Surface Shape of Anti-Reflection Coating and Observation of Shape of Optical Component]

In the following experimental examples, the surface shape of the anti-smudge coating of an optical component was measured and evaluated in the following manner.

After formation of an anti-reflection coating and an anti-smudge coating on a transparent base body, a plane profile of the anti-smudge coating was measured with a scanning probe microscope (manufactured by Seiko Instruments Inc., model: SPA400). The measurement mode was DFM mode, and the scanning area was 3 μm×3 μm. The value of a surface roughness Ra was obtained from the obtained plane profile based on JIS B 0601 (2001).

Infrequently, the anti-smudge coating material locally coagulates to make Ra specifically large. In such a case, it is necessary to exclude that part from calculation.

Furthermore, the shape of a sample surface after deposition of the anti-smudge coating was observed using a scanning electron microscope (manufactured by Hitachi High-Technologies Corporation, Model: SU8020).

### [Rubbing Durability (Wear Resistance) Test and Measurement of Water Contact Angle of Anti-Smudge Coating]

In the following experimental examples, with respect to a sample after formation of the anti-smudge coating, a rubbing durability test was conducted on the anti-smudge coating of the sample according to the following procedure.

First, a rubbing test was conducted on the anti-smudge coating of each experimental example according to the following procedure.

Steel wool #0000 was attached to a surface of a flat metal indenter having a bottom surface of 10 mm×10 mm to prepare a friction block to rub a sample.

Next, a rubbing test was conducted with a three-specimen plane abrasion tester (manufactured by Daiei Kagaku Seiki MFG. Co., Ltd., model: PA-300A) using the above-described friction block. Specifically, first, the above-described friction block was attached to the abrasion tester so that a bottom surface of the friction block comes into contact with the surface of the anti-smudge coating of the sample, a weight was placed on the abrasion tester so as to apply a weight of 1000 g to the friction block, and the abrasion tester was slid in a reciprocative manner 40 mm each way at an average speed of 6400 mm/min. The rubbing test was conducted, so that the number of times of rubbing was 2000, where one reciprocation was counted as one time of rubbing.

Thereafter, a water contact angle was measured with respect to the anti-smudge coating according to the following procedure.

The water contact angle of the anti-smudge coating was measured by dropping 1 μL of pure water onto the anti-smudge coating and measuring its water contact angle using an automatic contact angle meter (manufactured by Kyowa Interface Science Co., Ltd., model: DM-501). In the measurement, measurement was performed at ten points on the surface of the anti-smudge coating with respect to each sample, and the average was determined as the water contact angle of the sample.

On this occasion, a water contact angle of 90° or more was evaluated as acceptable and a water contact angle of less than 90° was evaluated as disqualified.

### (2) Procedure of Experiment

A description is given below of the procedure of each experimental example. Examples 1 to 5 and 7 are working examples, and Example 6 is a comparative example.

### Example 1

An optical component was produced according to the following procedure.

A chemically strengthened glass base body (manufactured by Asahi Glass Co., Ltd., Dragontrail (registered trademark)) was used as a transparent base body.

An anti-reflection coating was deposited on one surface of the transparent base body according to the following procedure.

First, while introducing a gas mixture having 10 vol % of oxygen gas mixed into argon gas, pulsed sputtering was performed using a niobium oxide target (manufactured by AGC Ceramics Co., Ltd., product name: NBO Target) under the conditions of a pressure of 0.3 Pa, a frequency of 20 kHz, a power density of 3.8 W/cm², and a reverse pulse width of 5 μs, so that a high refractive index layer formed of niobium oxide (niobia) having a thickness of 14 nm was deposited on one surface of the transparent base body.

Next, while introducing a gas mixture having 40 vol % of oxygen gas mixed into argon gas, pulsed sputtering was performed using a silicon target under the conditions of a pressure of 0.3 Pa, a frequency of 20 kHz, a power density of 3.8 W/cm², and a reverse pulse width of 5 μs, so that a low refractive index layer formed of silicon oxide (silica) having a thickness of 35 nm was deposited on the high refractive index layer.

Next, while introducing a gas mixture having 10 vol % of oxygen gas mixed into argon gas, pulsed sputtering was performed using a niobium oxide target (manufactured by AGC Ceramics Co., Ltd., product name: NBO Target) under the conditions of a pressure of 0.3 Pa, a frequency of 20 kHz, a power density of 3.8 W/cm², and a reverse pulse width of 5 μs, so that a high refractive index layer formed of niobium oxide (niobia) having a thickness of 118 nm was deposited on the low refractive index layer.

Next, while introducing a gas mixture having 40 vol % of oxygen gas mixed into argon gas, pulsed sputtering was performed using a silicon target under the conditions of a pressure of 0.3 Pa, a frequency of 20 kHz, a power density of 3.8 W/cm², and a reverse pulse width of 5 μs, so that a low refractive index layer formed of silicon oxide (silica) having a thickness of 84 nm was deposited.

Thus, an anti-reflection coating having niobium oxide (niobia) and silicon oxide (silica) stacked in four layers in total was deposited.

Next, an anti-smudge coating was deposited on the anti-reflection coating according to the following procedure.

First, an anti-smudge coating material A (manufactured by Daikin Industries, Ltd., product name: Optool (registered trademark) DSX Agent) was introduced into a heating container. Thereafter, the heating container was degassed for 10 hours or more with a vacuum pump to remove a solvent in the solution, so as to prepare a composition for forming a fluorinated organosilicon compound coating.

Next, the heating container containing the composition for forming a fluorinated organosilicon compound coating was heated to 270° C. After arriving at 270° C., the state was maintained for 10 minutes until the temperature was stabilized.

Then, the composition for forming a fluorinated organosilicon compound coating was fed through a nozzle connected to the heating container containing the composition for forming a fluorinated organosilicon compound coating, and was deposited on the anti-reflection coating stacked on the transparent base body placed in a vacuum chamber.

The deposition was performed while measuring a film thickness with a crystal unit monitor placed in the vacuum chamber, until a fluorinated organosilicon compound coating deposited on the transparent base body became 7 nm in thickness.

When the fluorinated organosilicon compound coating became 7 nm in thickness, the feeding of the raw material through the nozzle was stopped, and a produced optical component was thereafter taken out of the vacuum chamber.

The taken-out optical component was placed on a hot plate with a coating surface facing upward, and was subjected to heat treatment in the air at 150° C. for 60 minutes.

The above-described measurement of a surface roughness and rubbing durability test were performed on the sample thus obtained.

The results are shown in Table 1. Furthermore, the result of observation of a surface shape with the scanning electron microscope (manufactured by Hitachi High-Technologies Corporation, Model: SU8020) is shown in FIG. 2. In FIG. 2, the area indicated by 21 is an upper surface part of the optical component, that is, the anti-smudge coating surface, and corresponds to a part 13A in FIG. 1. Furthermore, the area indicated by 22 is a side surface of the optical component, and corresponds to, for example, a part 10A in FIG. 1.

### Example 2

An optical component was produced according to the following procedure.

A chemically strengthened glass base body (manufactured by Asahi Glass Co., Ltd., product name: Dragontrail (registered trademark)) was used as a transparent base body.

An anti-reflection coating was deposited on one surface of the transparent base body according to the following procedure.

First, while introducing a gas mixture having 10 vol % of oxygen gas mixed into argon gas, AC sputtering was performed using two niobium oxide targets (manufactured by AGC Ceramics Co., Ltd., product name: NBO Target) under the conditions of a pressure of 0.3 Pa, a frequency of 30 kHz, and a power density of 3.8 W/cm², so that a high refractive index layer formed of niobium oxide (niobia) having a thickness of 14 nm was deposited on one surface of the transparent base body.

Next, while introducing a gas mixture having 40 vol % of oxygen gas mixed into argon gas, AC sputtering was performed using two silicon targets under the conditions of a pressure of 0.3 Pa, a frequency of 30 kHz, and a power density of 3.8 W/cm², so that a low refractive index layer formed of silicon oxide (silica) having a thickness of 35 nm was deposited on the high refractive index layer.

Next, while introducing a gas mixture having 10 vol % of oxygen gas mixed into argon gas, AC sputtering was performed using two niobium oxide targets (manufactured by AGC Ceramics Co., Ltd., product name: NBO Target) under the conditions of a pressure of 0.3 Pa, a frequency of 30 kHz, and a power density of 3.8 W/cm², so that a high refractive index layer formed of niobium oxide (niobia) having a thickness of 118 nm was deposited on the low refractive index layer.

Next, while introducing a gas mixture having 40 vol % of oxygen gas mixed into argon gas, AC sputtering was performed using two silicon targets under the conditions of a pressure of 0.3 Pa, a frequency of 30 kHz, and a power density of 3.8 W/cm², so that a low refractive index layer formed of silicon oxide (silica) having a thickness of 84 nm was deposited.

Thus, an anti-reflection coating having niobium oxide (niobia) and silicon oxide (silica) stacked in four layers in total was deposited.

Thereafter, an anti-smudge coating was deposited in the same manner as in Example 1.

The above-described measurement of a surface roughness and rubbing durability test were performed on the sample thus obtained. The results are shown in Table 1.

### Example 3

An optical component was produced according to the following procedure.

A chemically strengthened glass base body (manufactured by Asahi Glass Co., Ltd., product name: Dragontrail (registered trademark)) was used as a transparent base body. As a thin film deposition apparatus, an apparatus including a cathode having a Ta target, a cathode having a Si target, a plasma source, and a rotating drum on which the transparent base body was settable was used. Then, an anti-reflection coating was deposited on one surface of the transparent base body according to the following procedure.

After the degree of vacuum of the thin film deposition apparatus became 2×10⁻⁴ Pa or less, argon gas was introduced to the Ta target at 40 sccm and oxygen gas was introduced to the plasma source at 180 sccm. Thereafter, sputtering was performed by inputting a power of 3 kW to the cathode of the Ta target and a power of 1.1 kW to the plasma source, so that a high refractive index layer having a thickness of 14 nm and a refractive index (n) of 2.20 was deposited.

Next, argon gas was introduced to the Si target at 30 sccm and oxygen gas was introduced to the plasma source at 180 sccm. Thereafter, sputtering was performed by inputting a power of 6 kW to the cathode of the Si target and a power of 0.95 kW to the plasma source, so that a low refractive index layer having a thickness of 33 nm and a refractive index (n) of 1.48 was deposited on the high refractive index layer.

Thereafter, on this low refractive index layer, a high refractive index layer of 121 nm in thickness was deposited using the same material and in the same manner as the above-described high refractive index layer. Furthermore, on this high refractive index layer, a low refractive index layer of 81 nm in thickness was deposited using the same material and in the same manner as the above-described low refractive index layer.

In this manner, an anti-reflection coating having tantalum oxide and silicon oxide (silica) stacked in four layers in total was deposited.

Next, an anti-smudge coating was deposited in the same manner as in Example 1.

The above-described measurement of a surface roughness and rubbing durability test were performed on the sample thus obtained. The results are shown in Table 1.

### Example 4

According to this working example, an optical component was produced in the same manner as in Example 2 except that the material for depositing an anti-smudge coating was an anti-smudge coating material B (manufactured by Shin-Etsu Chemical Co., Ltd., product name: KY-185).

The above-described measurement of a surface roughness and rubbing durability test were performed on the sample thus obtained. The results are shown in Table 1.

### Example 5

An optical component was produced according to the following procedure.

A chemically strengthened glass base body (manufactured by Asahi Glass Co., Ltd., product name: Dragontrail (registered trademark)) was used as a transparent base body. As a thin film deposition apparatus, an apparatus including a cathode having a Si target, a cathode having a Sn-containing Si target, a plasma source, and a rotating drum on which the transparent base body was settable was used. Then, an anti-reflection coating was deposited on one surface of the transparent base body according to the following procedure.

After the degree of vacuum of the thin film deposition apparatus became 2×10⁻⁴ Pa or less, argon gas was introduced to the Si target at 85 sccm and nitrogen gas was introduced to the plasma source at 105 sccm. Thereafter, sputtering was performed by inputting a power of 6 kW to the cathode of the Si target and a power of 0.55 kW to the plasma source, so that a high refractive index layer having a thickness of 26 nm and a refractive index (n) of 2.09 was deposited.

Next, argon gas was introduced to each of the Si target and the Sn-containing Si target at 40 sccm and oxygen gas was introduced to the plasma source at 140 sccm. Thereafter, sputtering was performed by inputting a power of 6 kW to the cathode of the Si target, a power of 0.6 kW to the Sn-containing Si target, and a power of 0.85 kW to the plasma source, so that a low refractive index layer having a thickness of 30 nm and a refractive index (n) of 1.49 was deposited on the high refractive index layer.

Thereafter, on this low refractive index layer, a high refractive index layer of 50 nm in thickness was deposited using the same material and in the same manner as the above-described high refractive index layer. Furthermore, on this high refractive index layer, a low refractive index layer of 88 nm in thickness was deposited using the same material and in the same manner as the above-described low refractive index layer.

In this manner, an anti-reflection coating having silicon nitride and a mixed oxide of Si and Sn stacked in four layers in total was deposited.

This time, a Si target and a Sn-containing Si target were used. Alternatively, low refractive index layers may be deposited using a Sn-containing Si target alone. Furthermore, a Sn-containing Si target was used this time, while a Zr-containing Si target or an Al-containing Si target may be an alternative.

Next, an anti-smudge coating was deposited in the same manner as in Example 1.

The above-described measurement of a surface roughness and rubbing durability test were performed on the sample thus obtained. The results are shown in Table 1.

### Example 6

According to this experimental example, an optical component was produced in the same manner as in Example 1 except that the conditions for depositing an anti-reflection coating were as follows.

That is, an anti-reflection coating having niobium oxide (niobia) and silicon oxide (silica) stacked in four layers in total was deposited in the same manner as in Example 1 except that the pressure during deposition was 0.7 Pa. Thereafter, an anti-smudge coating was deposited in the same manner as in Example 1, and the measurement of a surface roughness and the rubbing durability test were performed.

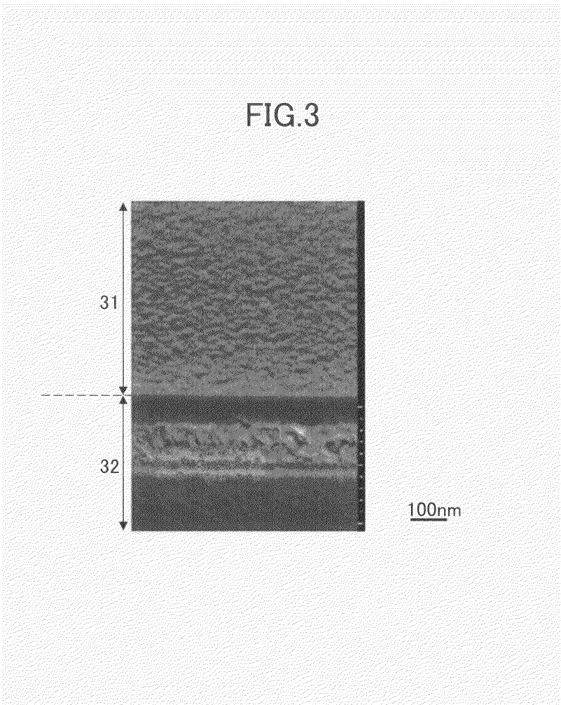

The results are shown in Table 1. Furthermore, the result of observation of a surface shape with the scanning electron microscope is shown in FIG. 3. In FIG. 3, the area indicated by 31 is an upper surface part of the optical component, that is, the anti-smudge coating surface, and corresponds to the part 13A in FIG. 1. Furthermore, the area indicated by 32 is a side surface of the optical component, and corresponds to, for example, the part 10A in FIG. 1.

### Example 7

An optical component was produced according to the following procedure.

A sapphire base body (manufactured by Shinkosha Co., Ltd.) was used as a transparent base body. As a thin film deposition apparatus, an apparatus including a cathode having a Si target, a cathode having an Al target, a plasma source, and a rotating drum on which the transparent base body was settable was used. Then, an anti-reflection coating was deposited on one surface of the transparent base body according to the following procedure.

After the degree of vacuum of the thin film deposition apparatus became 2×10⁻⁴ Pa or less, argon gas was introduced to the Si target at 85 sccm and nitrogen gas was introduced to the plasma source at 105 sccm. Thereafter, sputtering was performed by inputting a power of 6 kW to the cathode of the Si target and a power of 0.55 kW to the plasma source, so that a high refractive index layer having a thickness of 17 nm and a refractive index (n) of 2.09 was deposited.

Next, argon gas was introduced to each of the Si target and the Al target at 40 sccm and oxygen gas was introduced to the plasma source at 140 sccm. Thereafter, sputtering was performed by inputting a power of 6 kW to the cathode of the Si target, a power of 4 kW to the Al target, and a power of 0.85 kW to the plasma source, so that a low refractive index layer having a thickness of 21 nm and a refractive index (n) of 1.49 was deposited on the high refractive index layer.

Thereafter, on this low refractive index layer, a high refractive index layer of 134 nm in thickness was deposited using the same material and in the same manner as the above-described high refractive index layer. Furthermore, on this high refractive index layer, a low refractive index layer of 82 nm in thickness was deposited using the same material and in the same manner as the above-described low refractive index layer.

In this manner, an anti-reflection coating having silicon nitride and a mixed oxide of Si and Al stacked in four layers in total was deposited.

This time, a Si target and an Al target were used to form a mixed oxide of Si and Al. Alternatively, an Al-containing Si target may be used to deposit a low refractive index layer. Furthermore, the low refractive index layer may be, for example, a material containing a mixed oxide of Si and Sn or a material containing a mixed oxide of Si and Zr. Therefore, while an Al target was used this time, a Zr target or a Sn target may be used in place of the Al target.

Next, an anti-smudge coating was deposited in the same manner as in Example 1 except that the material for depositing an anti-smudge coating was an anti-smudge coating material C (manufactured by Shin-Etsu Chemical Co., Ltd., product name: KY-178).

The above-described measurement of a surface roughness and rubbing durability test were performed on the sample thus obtained. The results are shown in Table 1.

TABLE 1

| | | | Ex. 1 | Ex. 2 | Ex. 3 | Ex. 4 |
|---|---|---|---|---|---|---|
| BASE MATERIAL | | | CHEMICALLY STRENGTHENED GLASS | | | |
| ANTI-REFLECTION COATING | | | PULSED | AC | DIGITAL | AC |
| DEPOSITION METHOD | | | SPUTTERING | SPUTTERING | SPUTTERING | SPUTTERING |
| MATERIAL | ANTI-REFLECTION | 1^{ST} | Nb₂O₅ | Nb₂O₅ | Ta₂O₅ | Nb₂O₅ |
| | COATING | LAYER | | | | |
| | | 2^{ND} | SiO₂ | SiO₂ | SiO₂ | SiO₂ |
| | | LAYER | | | | |
| | | 3^{RD} | Nb₂O₅ | Nb₂O₅ | Ta₂O₅ | Nb₂O₅ |
| | | LAYER | | | | |
| | | 4^{TH} | SiO₂ | SiO₂ | SiO₂ | SiO₂ |
| | | LAYER | | | | |
| | ANTI-SMUDGE | 5^{TH} | OPTOOL | OPTOOL | OPTOOL | KY185 |
| | COATING | LAYER | (REGISTERED | DSX | DSX | |
| | | | TRADEMARK) | | | |
| | | | DSX | | | |
| FILM | ANTI-REFLECTION | 1^{ST} | 14 | 14 | 14 | 14 |
| THICKNESS | COATING | LAYER | | | | |
| (mm) | | 2^{ND} | 35 | 35 | 33 | 35 |
| | | LAYER | | | | |
| | | 3^{RD} | 118 | 118 | 121 | 118 |
| | | LAYER | | | | |
| | | 4^{TH} | 84 | 84 | 81 | 84 |
| | | LAYER | | | | |
| | ANTI-SMUDGE | 5^{TH} | 7 | 7 | 7 | 7 |
| | COATING | LAYER | | | | |

| | | | | |
|---|---|---|---|---|
| SURFACE ROUGHNESS Ra OF | 1.8 | 1.1 | 0.3 | 1.1 |
| ANTI-SMUDGE COATING | | | | |
| (5^{TH} LAYER) (nm) | | | | |
| WATER CONTACT ANGLE OF | 94° | 98° | 110° | 102° |
| ANTI-SMUDGE COATING AFTER | | | | |
| RUBBING DURABILITY TEST | | | | |

| | | | Ex. 5 | Ex. 6 | Ex. 7 |
|---|---|---|---|---|---|
| BASE MATERIAL | | | CHEMICALLY | | SAPPHIRE |
| | | | STRENGTHENED GLASS | | |
| ANTI-REFLECTION COATING | | | DIGITAL | PULSED | DIGITAL |
| DEPOSITION METHOD | | | SPUTTERING | SPUTTERING | SPUTTERING |
| MATERIAL | ANTI-REFLECTION | 1^{ST} | Si₃N₄ | Nb₂O₅ | Si₃N₄ |
| | COATING | LAYER | | | |
| | | 2^{ND} | Si AND Sn | SiO₂ | Si AND Al |
| | | LAYER | MIXED OXIDE | | MIXED OXIDE |
| | | 3^{RD} | Si₃N₄ | Nb₂O₅ | Si₃N₄ |
| | | LAYER | | | |
| | | 4^{TH} | Si AND Sn | SiO₂ | Si AND Al |
| | | LAYER | MIXED OXIDE | | MIXED OXIDE |
| | ANTI-SMUDGE | 5^{TH} | OPTOOL | OPTOOL | KY178 |
| | COATING | LAYER | DSX | DSX | |
| FILM | ANTI-REFLECTION | 1^{ST} | 26 | 14 | 17 |
| THICKNESS | COATING | LAYER | | | |
| (mm) | | 2^{ND} | 30 | 35 | 21 |
| | | LAYER | | | |
| | | 3^{RD} | 50 | 118 | 134 |
| | | LAYER | | | |
| | | 4^{TH} | 88 | 84 | 82 |
| | | LAYER | | | |
| | ANTI-SMUDGE | 5^{TH} | 7 | 7 | 7 |
| | COATING | LAYER | | | |

| | | | |
|---|---|---|---|
| SURFACE ROUGHNESS Ra OF | 0.3 | 3.4 | 0.5 |
| ANTI-SMUDGE COATING | | | |
| (5^{TH} LAYER) (nm) | | | |
| WATER CONTACT ANGLE OF | 108° | 60° | 105° |
| ANTI-SMUDGE COATING AFTER | | | |
| RUBBING DURABILITY TEST | | | |

According to the results shown in Table 1, the water contact angle is 90° or more and meets the acceptability criterion in the rubbing durability test with respect to Examples 1 to 5 and 7, which satisfy the prescription of the present invention, but is 60° and fails to meet the acceptability criterion with respect to Example 6, which is a comparative example.

According to Example 6, the water contact angle after the rubbing durability test is extremely small, which shows that the anti-smudge coating is removed or worn. It is believed that this is because the surface roughness Ra of the anti-smudge coating is 3.4 nm and is relatively large compared with Examples 1 to 5.

Thus, it has been found that the durability of the anti-smudge coating is extremely high in Examples 1 to 5 and 7, which satisfy the prescription of the present invention, compared with Example 6, which is a comparative example.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. An optical component is described above based on one or more embodiments of the present invention. It should be understood, however, that the various changes, substitutions, and alterations could be made hereto without departing from the spirit and scope of the invention.

What is claimed is:

1. An optical component, comprising:
a transparent base body;
an anti-reflection coating stacked on the transparent base body; and
an anti-smudge coating stacked on the anti-reflection coating,
wherein a surface roughness Ra of the anti-smudge coating is 3 nm or less.

2. The optical component as claimed in claim 1, wherein the transparent base body is a glass substrate.

3. The optical component as claimed in claim 1, wherein the transparent base body is a sapphire substrate.

4. The optical component as claimed in claim 1, wherein
the anti-reflection coating is a stack of a high refractive index layer and a low refractive index layer,
the high refractive index layer is one selected from a niobium oxide layer and a tantalum oxide layer, and
the low refractive index layer is a silicon oxide layer.

5. The optical component as claimed in claim 1, wherein
the anti-reflection coating is a stack of a high refractive index layer and a low refractive index layer,
the high refractive index layer is a silicon nitride layer, and
the low refractive index layer is one of a material containing a mixed oxide of Si and Sn, a material containing a mixed oxide of Si and Zr, and a material containing a mixed oxide of Si and Al.

6. The optical component as claimed in claim 1, wherein
the anti-reflection coating is a stack of a plurality of stacked layers, and
two through six layers are stacked in the stack in entirety thereof.
